(19) United States
(12) Patent Application Publication
(10) Pub. No.: US 2014/0065257 A1
(43) Pub. Date: Mar. 6, 2014

(54) INJECTION MOLDING APPARATUS

(71) Applicant: Aisin Seiki Kabushiki Kaisha, Kariya-shi (JP)

(72) Inventors: Shogo IZAWA, Tokai-shi (JP); Hiroki Hara, Toyota-shi (JP); Ryohei Higuchi, Kariya-shi (JP)

(73) Assignee: Aisin Seiki Kabushiki Kaisha, Kariya-shi (JP)

(21) Appl. No.: 14/016,529

(22) Filed: Sep. 3, 2013

(30) Foreign Application Priority Data
Sep. 3, 2012 (JP) 2012-192818

(51) Int. Cl. B29C 45/74

(52) U.S. Cl. CPC B29C 45/74
USPC 425/551

(57) ABSTRACT

An injection molding apparatus includes a heating device heating reinforcing fiber assemblies, an injection cylinder to which a thermoplastic resin and the reinforcing fiber assemblies are supplied, a first screw compressing and kneading the thermoplastic resin, a second screw fibrillating the reinforcing fiber assemblies and dispersing reinforcing fibers obtained by the fibrillation into the thermoplastic resin, a resin supply portion supplying the thermoplastic resin to a void formed between the injection cylinder and the first screw, and a reinforcing fiber supply portion supplying the reinforcing fiber assemblies to a void formed between the injection cylinder and the second screw. The second screw serves as one of a non-compression screw and a low compression screw including a low compression ratio by which the reinforcing fibers are inhibited from being excessively broken at a time of receiving a shearing force generated by a rotation of the second screw.

### CROSS REFERENCE TO RELATED APPLICATIONS

This application is based on and claims priority under 35 U.S.C. §119 to Japanese Patent Application 2012-192818, filed on Sep. 3, 2012, the entire content of which is incorporated herein by reference.

### TECHNICAL FIELD

This disclosure generally relates to an injection molding apparatus.

### BACKGROUND DISCUSSION

In order to improve strength of a resin injection molded part, a technology of injection molding of a molten resin including reinforcing fibers, for example, including carbon fibers or glass fibers, has been developed.

JP2009-242616A, which will be hereinafter referred to as Reference 1, discloses an injection molding apparatus for performing an injection molding by kneading and mixing reinforcing fibers in strand form, serving as reinforcing fiber assemblies formed by plural reinforcing fibers bonded by a sizing agent, with a thermoplastic resin by a twin screw extruder and thereafter supplying a resulting mixture to an injection cylinder. According to the injection molding apparatus disclosed in Reference 1, in addition to the reinforcing fibers in strand form and the thermoplastic resin, granular solids each of which includes an aspect ratio of 1 to 5 and an average grain size equal to or smaller than 10 μm are added within the twin screw extruder. The granular solids function as lubricant to restrain excessive fiber breaking within the twin screw extruder and the injection cylinder.

JP2003-181877A, which will be hereinafter referred to as Reference 2, discloses another injection molding apparatus configured to perform an injection molding after preheating a composite molding material including reinforcing fibers and resin, i.e., fiber-reinforced pellets, by hot air, for example. Because of the preheating, the fiber-reinforced pellets are softened to thereby restrain fiber breaking in the fiber-reinforced pellets.

FIG. 7 is a graph illustrating a relation between material properties of a resin molding material including reinforcing fibers and a fiber length of each reinforcing fiber contained in resin. The material properties include modulus, strength, and impact resistance. In FIG. 7, a horizontal axis indicates the fiber length of the reinforcing fiber while a vertical axis indicates the material properties. The material properties, i.e., the modulus, strength, and impact resistance, increase in association with an increase of the fiber length of the reinforcing fiber.

In a case where resin including reinforcing fibers is mixed and kneaded by a full-flight screw including a normal compression ratio, i.e., a compression ratio ranging from 2.0 to 4.0, within an injection cylinder, excessive fiber breaking may occur due to a shearing force applied to the reinforcing fibers passing through a clearance formed between the full-flight screw and the injection cylinder. In a case where the fiber length of each reinforcing fiber before the reinforcing fibers are supplied to the injection cylinder is 10 mm, for example, the fiber length of reinforcing fiber contained in resin that is injected from the injection cylinder may be 1 mm to 2 mm. The degree of fiber breaking may decrease somewhat by modification and improvement of a screw design including a compression ratio and a groove width of the screw, or by the addition of granular solids for lubrication as disclosed in Reference 1 or the preheating as disclosed in Reference 2. Nevertheless, because of a large influence of shearing force to the fiber breaking caused by a rotation of the screw, the fiber length may increase by 2 mm to 3 mm at most even by the aforementioned modification and improvement.

A need thus exists for an injection molding apparatus which is not susceptible to the drawback mentioned above.

### SUMMARY

According to an aspect of this disclosure, an injection molding apparatus includes a heating device heating reinforcing fiber assemblies that are formed by plural reinforcing fibers bonded together by a sizing agent, an injection cylinder to which a thermoplastic resin and the reinforcing fiber assemblies heated by the heating device are supplied, a first screw arranged to be rotatable within the injection cylinder, the first screw compressing and kneading the thermoplastic resin supplied into the injection cylinder within the injection cylinder, a second screw arranged within the injection cylinder and connected to an end portion of the first screw to be integrally rotatable with the first screw, the second screw fibrillating the reinforcing fiber assemblies supplied into the injection cylinder and dispersing reinforcing fibers obtained by the fibrillation into the thermoplastic resin, a resin supply portion supplying the thermoplastic resin to a void within the injection cylinder, the void being formed between the injection cylinder and the first screw, and a reinforcing fiber supply portion supplying the reinforcing fiber assemblies heated by the heating device to a void within the injection cylinder, the void being formed between the injection cylinder and the second screw. The second screw serves as one of a non-compression screw and a low compression screw including a low compression ratio by which the reinforcing fibers are inhibited from being excessively broken at a time of receiving a shearing force generated by a rotation of the second screw within the injection cylinder.

According to another aspect of this disclosure, an injection molding apparatus includes a selective heating device selectively heating plural reinforcing fibers in fiber-reinforced pellets each of which includes a thermoplastic resin containing the plural reinforcing fibers, an injection cylinder to which the fiber-reinforced pellets heated by the selective heating device are supplied, and an injection screw arranged to be rotatable within the injection cylinder to knead the fiber-reinforced pellets supplied into the injection cylinder. The injection screw serves as one of a non-compression screw and a low compression screw including a low compression ratio by which the reinforcing fibers are inhibited from being excessively broken at a time of receiving a shearing force generated by a rotation of the injection screw within the injection cylinder.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view illustrating an injection molding apparatus according to a first embodiment disclosed here;

FIG. 2 is a side view illustrating an example of a two-stage screw of the injection molding apparatus;

FIG. 3 is a schematic view illustrating an inner configuration of a heating chamber of the injection molding apparatus;

FIG. 4 is a schematic view illustrating an example in which long carbon fiber assemblies in roving form are heated by a microwave heater according to a modified example of the first embodiment;

FIG. 5 is a schematic view illustrating an injection molding apparatus according to a second embodiment disclosed here;

FIG. 6A is a perspective view illustrating a long carbon fiber reinforcing pellet according to the second embodiment;

FIG. 6B is a plan view illustrating the long carbon fiber reinforcing pellet according to the second embodiment; and

FIG. 7 is a graph illustrating a relation between a fiber length of each reinforcing fiber contained in resin and material characteristics of a resin molding material containing reinforcing fibers.

### DETAILED DESCRIPTION

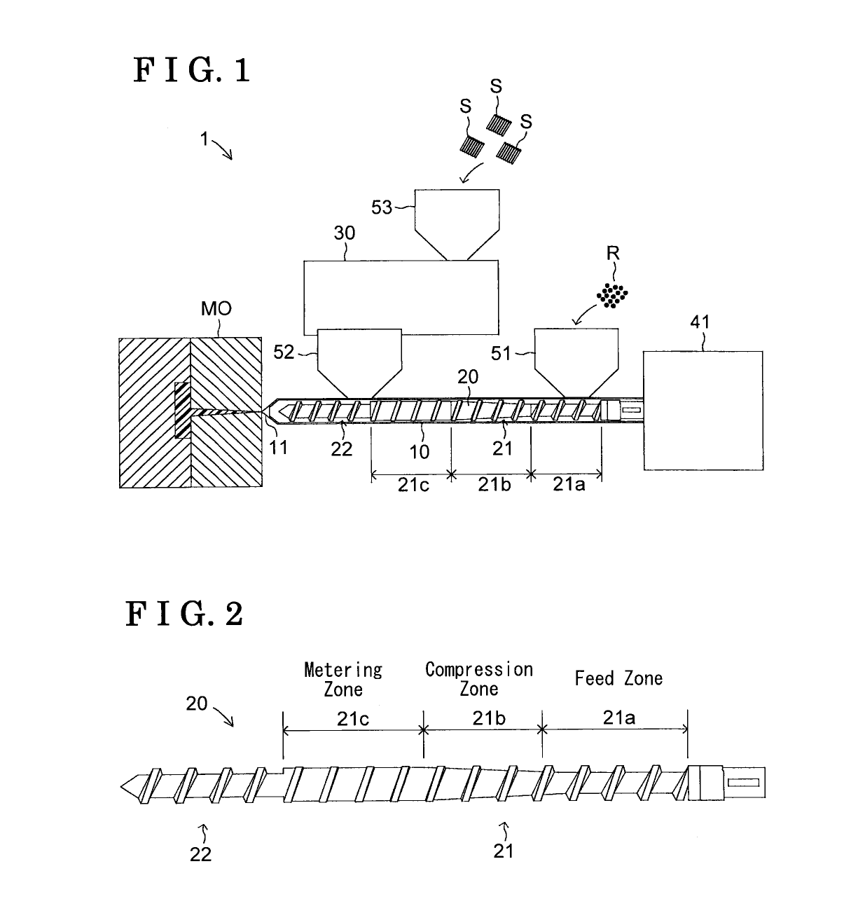

A first embodiment will be explained with reference to the attached drawings. As illustrated in FIG. 1, an injection molding apparatus 1 of the first embodiment includes an injection cylinder 10, a two-stage screw 20 arranged within the injection cylinder 10, and a heating chamber 30. In FIG. 1, a mold clamping device, a heater for the injection cylinder 10, an operation control unit, and a temperature control unit, for example, are omitted. Hereinafter, a left side in FIGS. 1 to 4 is referred to as a front side while a right side in FIGS. 1 to 4 is referred to as a rear side.

The injection cylinder 10 is configured to extend in a predetermined axial direction. A void is formed in column at an inside of the injection cylinder 10. A nozzle 11 is attached to a front end of the injection cylinder 10. A molten resin within the injection cylinder 10 is injected from the nozzle 11 to a mold MO. The molten resin injected from the nozzle 11 fills a cavity of the mold MO. The heater, which is provided at an outer periphery of the injection cylinder 10, is operated to heat the injection cylinder 10 so as to obtain a desired temperature of the molten resin within the injection cylinder 10.

The two-stage screw 20 is arranged within the injection cylinder 10 along an axial direction thereof to be rotatable about an axis. A drive unit 41 is connected to a rear end of the two-stage screw 20. The drive unit 41 includes, for example, an electric motor generating a driving force for rotating the two-stage screw 20 about the axis thereof.

As illustrated in FIG. 2, the two-stage screw 20 includes a screw portion for melting resin, which will be hereinafter referred to as a first screw portion 21 serving as a first screw, and a screw portion for dispersing and conveying long carbon fibers serving as reinforcing fibers, which will be hereinafter referred to as a second screw portion 22 serving as a second screw. The second screw portion 22 is connected to a front end of the first screw portion 21 serving as an end portion thereof. A rear end of the first screw portion 21 is connected to the drive unit 41. The first screw portion 21 and the second screw portion 22 may be integrally formed or may be separately manufactured and thereafter assembled on each other.

According to the present embodiment, a normal type of full-flight screw is utilized as the first screw portion 21. The first screw portion 21 includes a feed zone 21a, a compression zone 21b, and a metering zone 21c in the mentioned order from the rear end to the front end. The feed zone 21a is positioned in the rear of the compression zone 21b which is positioned in the rear of the metering zone 21c. According to the present embodiment, the first screw portion 21 includes a compression ratio ranging from 2.0 to 4.0 and an L/D ratio ranging from 16 to 25.

The second screw portion 22, of which a rear end is connected to the front end of the first screw portion 21, is coaxially arranged with the first screw portion 21. The second screw portion 22 integrally rotates with the first screw portion 21. According to the present embodiment, the second screw portion 22 includes a compression ratio of 1.0. That is, the second screw portion 22 is a non-compression screw. In addition, the second screw portion 22 includes an L/D ratio ranging from 10 to 15. The second screw portion 22 may serve as a low compression screw including the compression ratio equal to or smaller than 2.0.

As illustrated in FIG. 1, a primary hopper 51 serving as a resin supply portion and a secondary hopper 52 serving as a reinforcing fiber supply portion are provided at an upper side of the injection cylinder 10. The position at which the secondary hopper 52 is arranged relative to the injection cylinder 10 is in the front of the position at which the primary hopper 51 is arranged relative to the injection cylinder 10. Each of the primary and secondary hoppers 51 and 52 includes an upper opening and a lower opening. An inner void of each of the primary and secondary hoppers 51 and 52 is connected to an inner void of the injection cylinder 10 via each lower opening. Thermoplastic resin pellets R, which will be hereinafter referred to as resin pellets R, are input from the upper opening of the primary hopper 51. The resin pellets R contain polypropylene (PP) resin as a major component according to the present embodiment.

The heating chamber 30 is arranged at an upper side of the secondary hopper 52 in FIG. 1. The secondary hopper 52 and a chopped strand supply hopper 53 are connected to the heating chamber 30. The inner void of the secondary hopper 52 is connected via the upper opening thereof to an inner portion of the heating chamber 30. The chopped strand supply hopper 53 also includes an upper opening and a lower opening. An inner void of the chopped strand supply hopper 53 is connected via the lower opening thereof to the inner portion of the heating chamber 30. Assemblies of long carbon fibers, i.e., of reinforcing fibers, in chopped strand form, which will be hereinafter referred to as long carbon fiber assemblies S serving as reinforcing fiber assemblies, are supplied from the upper opening of the chopped strand supply hopper 53. The “assemblies of long carbon fibers in chopped strand form” correspond to assemblies of long carbon fibers formed by plural long carbon fibers including an extremely small diameter, for example, a diameter of 7 μm, and a predetermined length, for example, a length of 10 mm, and bonded by a sizing agent serving as a converging agent. According to the present embodiment, approximately twelve thousands to twenty-four thousands of long carbon fibers are bonded by the sizing agent to be bundled in chopped strand form to thereby obtain each of the long carbon fiber assemblies S. Each of the long carbon fiber assemblies S includes a width of approximately 10 mm and a fiber length of 10 mm. The aforementioned long carbon fiber assemblies S are supplied to the chopped strand supply hopper 53.

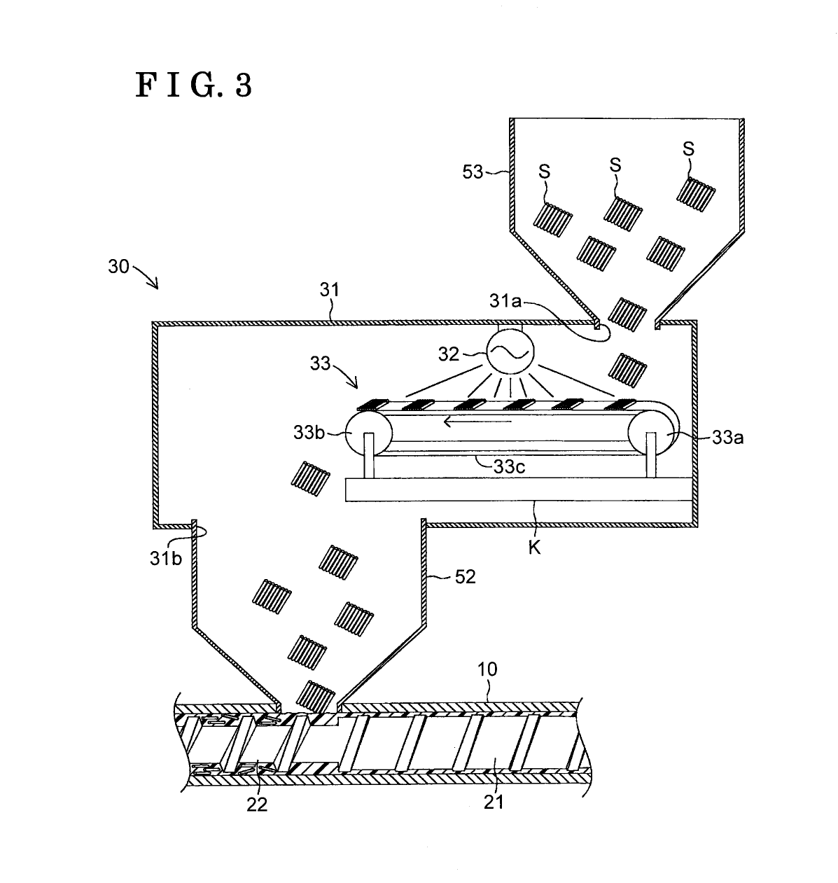

As illustrated in FIG. 3, the heating chamber 30 includes a case 31 forming an inner void, a microwave heater 32 serving as a heating device and an electromagnetic wave heating device, and a belt conveyor 33, the microwave heater 32 and the belt conveyor 33 being accommodated within the case 31. A first opening 31 a is formed at an upper wall of the case 31 at a relatively right side in FIG. 3. The first opening 31a is connected to the lower opening of the chopped strand supply hopper 53. In addition, a second opening 31b is formed at a lower wall of the case 31 at a relatively left side in FIG. 3. The second opening 31b is connected to the upper opening of the secondary hopper 52.

The microwave heater 32 is attached to the upper wall of the case 31 to output or radiate downwardly a microwave including a predetermined wavelength. The belt conveyor 33 is provided at a lower side of the microwave heater 32. The belt conveyor 33 includes a drive pulley 33a and a driven pulley 33b supported to be rotatable on a base K, and a conveyor belt 33c wound on the drive pulley 33a and the driven pulley 33b. A drive unit that is connected to the drive pulley 33a is operated to rotate the drive pulley 33a. The conveyor belt 33c rotates in a counterclockwise direction in FIG. 3 by the rotation of the drive pulley 33a. Items or articles placed on an upper side portion of the conveyor belt 33c are conveyed in association with the rotation of the conveyor belt 33c.

An injection molding method by the injection molding apparatus 1 including the aforementioned configuration will be explained.

First, the heater provided at the outer periphery of the injection cylinder 10 is operated to increase the temperature within the injection cylinder 10 to a desired temperature. In addition, the belt conveyor 33 within the heating chamber 30 is driven.

The plural resin pellets R are input to the primary hopper 51 and the plural long carbon fiber assemblies S are input to the chopped strand supply hopper 53. The resin pellets R input to the primary hopper 51 are supplied to the inside of the injection cylinder 10. As illustrated in FIG. 1, the lower opening of the primary hopper 51 faces the feed zone 21 a of the first screw portion 21 of the two-stage screw 20 arranged within the injection cylinder 10. Thus, the resin pellets R are supplied to a void between the injection cylinder 10 and the feed zone 21a of the two-stage screw 20. The resin pellets R supplied to the void between the injection cylinder 10 and the feed zone 21a are melted by heat. In addition, the rotation of the two-stage screw 20 by the driving of the drive unit 41 causes the resin pellets R to move forward in the first screw portion 21. The resin pellets R are then guided to the compression zone 21b to be compressed and kneaded thereat. The resin pellets R are further guided to the metering zone 21c from the compression zone 21b. The resin pellets R are sent from the metering zone 21c to the second screw portion 22.

The long carbon fiber assemblies S input to the chopped strand supply hopper 53 are supplied from the lower opening thereof to the heating chamber 30. As illustrated in FIG. 3, the lower opening of the chopped strand supply hopper 53 faces the upper side portion of the conveyor belt 33c of the belt conveyor 33. Therefore, the long carbon fiber assemblies S supplied into the heating chamber 30 fall onto the conveyor belt 33c to be conveyed thereby.

The microwave output or radiated from the microwave heater 32 is applied to the long carbon fiber assemblies S conveyed by the conveyor belt 33c. Specifically, according to the present embodiment, the microwave heater 32 outputs or generates downwardly in FIG. 3 an electromagnetic wave including a wavelength of 1 m to 100 μm, i.e., a frequency of 300 MHz to 3 THz, absorbable by the long carbon fibers in the long carbon fiber assemblies S. The long carbon fibers in the long carbon fiber assemblies S are immediately or instantaneously heated by absorbing the microwave output from the microwave heater 32. That is, the long carbon fiber assemblies S are heated while being conveyed by the belt conveyor 33, i.e., while moving. The heat of the long carbon fibers is transmitted to the sizing agent that bonds the long carbon fibers to thereby heat the sizing agent. Alternatively, in a case where the sizing agent in the long carbon fiber assemblies S is formed by resin including a polarity, the microwave heater 32 may be configured to send the electromagnetic wave including the wavelength that is absorbable by the sizing agent, to the long carbon fiber assemblies S. In this case, the sizing agent itself is heated by absorbing the microwave.

The sizing agent in the long carbon fiber assemblies S is softened and melted by being heated. The softening and melting of the sizing agent weakens the bonding force among the long carbon fibers. Accordingly, the long carbon fiber assemblies S in which the bonding force among the long carbon fibers is weakened are conveyed by the belt conveyor 33 to fall therefrom. The secondary hopper 52 is positioned immediately below a position at which the long carbon fiber assemblies S fall from the belt conveyor 33. As a result, the long carbon fiber assemblies S are input to the secondary hopper 52 from the upper opening thereof.

The long carbon fiber assemblies S input to the secondary hopper 52 are supplied to the inside of the injection cylinder 10 from the lower opening of the secondary hopper 52. As illustrated in FIG. 3, the lower opening of the secondary hopper 52 faces the vicinity of a rear end portion of the second screw portion 22, i.e., faces a portion of the second screw portion 22 close to the first screw portion 21, of the two-stage screw 20 arranged within the injection cylinder 10. Thus, the long carbon fiber assemblies S are supplied to a void between the injection cylinder 10 and the second screw portion 22.

The long carbon fiber assemblies S supplied to the void between the injection cylinder 10 and the second screw portion 22 are fibrillated by a rotation force of the second screw portion 22. As mentioned above, the sizing agent within the long carbon fiber assemblies S is softened and melted by heating and therefore the bonding force among the long carbon fibers is weakened. Thus, a small force applied to the long carbon fiber assemblies S by the rotation of the second screw portion 22 may cause the long carbon fiber assemblies S to be easily fibrillated. The long carbon fibers that are fibrillated are mixed with the molten resin sent from the first screw portion 21 to the second screw portion 22 and are dispersed into the molten resin.

The long carbon fiber assemblies S supplied to the injection cylinder 10 pass only through the second screw portion 22 in the two-stage screw 20. The long carbon fiber assemblies S are inhibited from passing through the first screw portion 21 in the two-stage screw 20. The second screw portion 22 is the non-compression screw including the compression ratio of 1.0. Thus, in a case where the molten resin including the long carbon fibers passes through the void between the injection cylinder 10 and the second screw portion 22, a shearing force applied from the second screw portion 22 to the molten resin and the long carbon fibers is small. Breaking of the long carbon fibers by the shearing force is minimized accordingly. That is, excessive breaking of the long carbon fibers is restrained. As a result, the molten resin including the long carbon fibers that include relatively elongated lengths because of restraint of excessive breaking is injected from the nozzle 11.

When the fiber lengths of the long carbon fibers taken from the molten resin, i.e., drawing resin, injected from the nozzle 11 were measured, the average length of the long carbon fibers was 8.5 mm. At this time, a blending quantity of the long carbon fibers was 40 wt %. The average fiber length of the long carbon fibers before the long carbon fibers were supplied to the injection cylinder 10, i.e., the average fiber length of the long carbon fibers constituting the long carbon fiber assemblies S was approximately 10 mm. Thus, the ratio of the average fiber length of the long carbon fibers in the drawing resin relative to the average fiber length of the long carbon fibers before the long carbon fibers are supplied to the injection cylinder 10 (i.e., fiber length ratio) is substantially 85%. In addition, the average fiber length of the long carbon fibers in the drawing resin was 1.4 mm when the resin pellets R formed by polypropylene resin and the long carbon fiber assemblies S were supplied from the primary hopper to the injection cylinder 10 in which a normal full-flight screw was accommodated for comparison. The fiber length ratio is substantially 14% in the comparison case. Accordingly, it is understood that the molten resin including the long carbon fibers that include the longer lengths than the known long carbon fibers is injected by the injection molding apparatus 1 of the present embodiment.

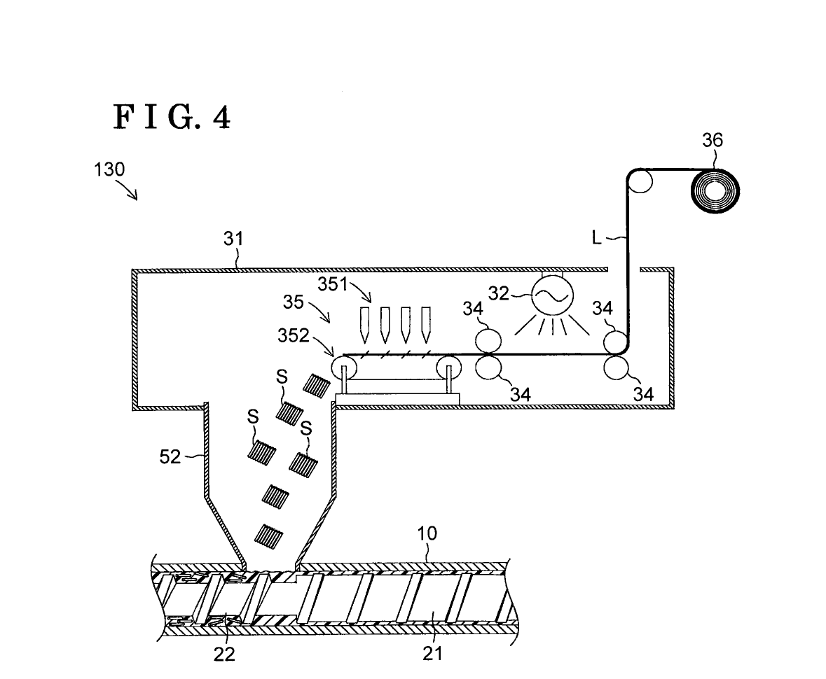

According to the aforementioned first embodiment, the long carbon fiber assemblies S in chopped strand form are heated by the microwave heater 32. Alternatively, the long carbon fiber assembly in roving form may be heated according to a modified example. FIG. 4 illustrates an example in which a long carbon fiber assembly L in roving form is heated by the microwave heater 32. As illustrated in FIG. 4, a heating chamber 130 includes the case 31, the microwave heater 32, conveyor rollers 34, and a cutting device 35. The long carbon fiber assembly L is supplied within the heating chamber 130 from a coil 36.

The long carbon fiber assembly L supplied within the heating chamber 130 is then fed to the cutting device 35 while being guided by the conveyor rollers 34 that are provided at appropriate portions within the case 31. In addition, while the long carbon fiber assembly L is being fed to the cutting device 35, the long carbon fibers within the long carbon fiber assembly L are instantly heated by the microwave heater 32 arranged within the case 31. In association with heating of the long carbon fibers, the heat thereof is transmitted to the sizing agent within the long carbon fiber assembly L. The sizing agent is also heated to be softened and melted. The long carbon fiber assembly L in which the bonding force among the long carbon fibers is weakened due to softening and melting of the sizing agent is supplied to the cutting device 35.

The cutting device 35 includes a cutter 351 and a belt conveyor 352. The long carbon fiber assembly L supplied to the cutting device 35 moves on the belt conveyor 352. The long carbon fiber assembly L on the belt conveyor 352 is cut to appropriate lengths by the cutter 351. As a result, the long carbon fiber assemblies S in chopped strand form are formed. The long carbon fiber assembly L formed in the aforementioned manner (i.e., the long carbon fiber assemblies S) falls to the secondary hopper 52 from the belt conveyor 352. According to the modified example, in the same way as the first embodiment, the long carbon fiber assemblies S are supplied into the injection cylinder 10 from the secondary hopper 52.

The long carbon fiber assemblies S supplied to the injection cylinder 10 are fibrillated by the rotation force of the second screw portion 22. As mentioned above, the sizing agent within the long carbon fiber assemblies S is softened and melted by heat within the heating chamber 130 and thus the bonding force among the long carbon fibers of the long carbon fiber assemblies S is weakened. Therefore, a small force applied to the long carbon fiber assemblies S by the rotation of the second screw portion 22 may cause the long carbon fiber assemblies S to be easily fibrillated. The long carbon fibers that are fibrillated are mixed with the molten resin guided from the first screw portion 21 to the second screw portion 22 to be dispersed within the molten resin, and are injected from the nozzle 11.

Accordingly, the injection molding apparatus 1 of the first embodiment includes the microwave heater 32 heating the long carbon fiber assemblies S formed by the plural long carbon fibers that are bonded together by the sizing agent, the injection cylinder 10 to which the thermoplastic resin and the long carbon fiber assemblies S heated by the microwave heater 32 are supplied, the first screw portion 21 arranged to be rotatable within the injection cylinder 10 to compress and knead the thermoplastic resin that is supplied into the injection cylinder 10 within the injection cylinder 10, and the second screw portion 22 arranged within the injection cylinder 10 and connected to the front end of the first screw portion 21 to be integrally rotatable with the first screw portion 21, the second screw portion 22 fibrillating the long carbon fiber assemblies S supplied into the injection cylinder 10 and dispersing the long carbon fibers obtained by the fibrillation into the thermoplastic resin. The injection molding apparatus 1 further includes the primary hopper 51 supplying the thermoplastic resin into the void within the injection cylinder 10 formed between the injection cylinder 10 and the first screw portion 21, and the secondary hopper 52 supplying the long carbon fiber assemblies S heated by the microwave heater 32 into the void within the injection cylinder 10 formed between the injection cylinder 10 and the second screw portion 22. The second screw portion 22 is the non-compression screw including the compression ratio of 1.0.

According to the first embodiment, the thermoplastic resin and the long carbon fiber assemblies S that are heated are supplied into the injection cylinder 10 from the primary hopper 51 and the secondary hopper 52, respectively. The thermoplastic resin supplied into the injection cylinder 10 from the primary hopper 51 is compressed and kneaded by the first screw portion 21 and is melted by heat applied to the injection cylinder 10 from the heater. Then, the thermoplastic resin in melted state is sent from the first screw portion 21 to the second screw portion 22. On the other hand, the long carbon fiber assemblies S supplied into the injection cylinder 10 from the secondary hopper 52 are fibrillated by the second screw portion 22 connected to the front end of the first screw portion 21 and are dispersed into the melted thermoplastic resin sent from the first screw portion 21. At this time, the long carbon fiber assemblies S supplied to the injection cylinder 10 have been already heated by the microwave heater 32, which results in the heating of the sizing agent that bonds the long carbon fibers. The sizing agent is generally formed by resin and thus is softened and melted by the application of heat. Therefore, the bonding force among the long carbon fibers within the long carbon fiber assemblies S supplied to the injection cylinder 10 has been already weakened by the softening and melting of the sizing agent that is caused by the application of heat. The long carbon fiber assemblies S may be easily fibrillated by receiving the rotation force of the second screw portion 22 accordingly. The long carbon fiber assemblies S that are fibrillated pass through only the second screw portion 22 in the two-stage screw 20, i.e., the long carbon fiber assemblies S are inhibited from passing through the first screw portion 21. Because of the rotation of the second screw portion 22 within the injection cylinder 10, the shearing force is applied to the molten resin and the long carbon fibers passing through the void, i.e., clearance, between the injection cylinder 10 and the second screw portion 22, specifically, the clearance between an inner wall of the injection cylinder 10 and an outer peripheral wall of a blade portion of the second screw portion 22. Nevertheless, because of a relatively small shearing force resulting from the non-compression screw or the low compression screw of the second screw portion 22, the excessive breaking of the long carbon fibers by the application of the shearing force to the long carbon fibers is inhibited. As a result, the excessive breaking of the long carbon fibers contained in the resin that is injected may be restrained.

In addition, the second screw portion 22 includes the L/D ratio of 10-15, which is smaller than an UD ratio of 16-25 of a normal full-flight screw. Thus, the long carbon fibers serving as the reinforcing fibers are inhibited from being excessively broken during the kneading.

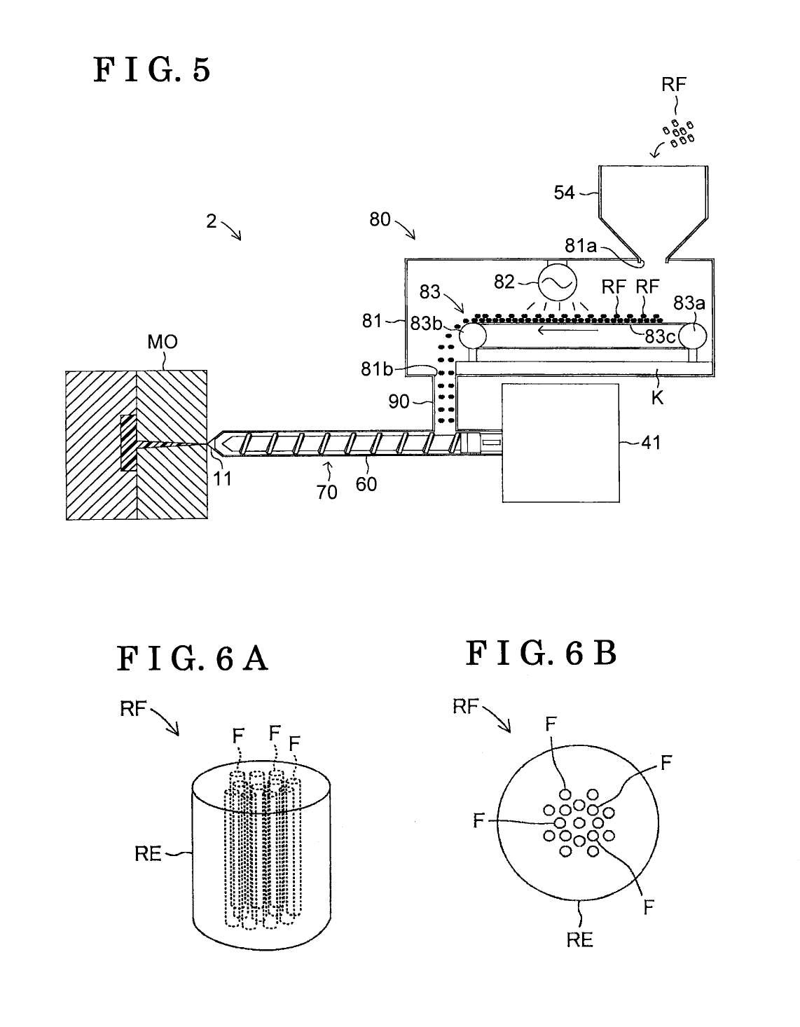

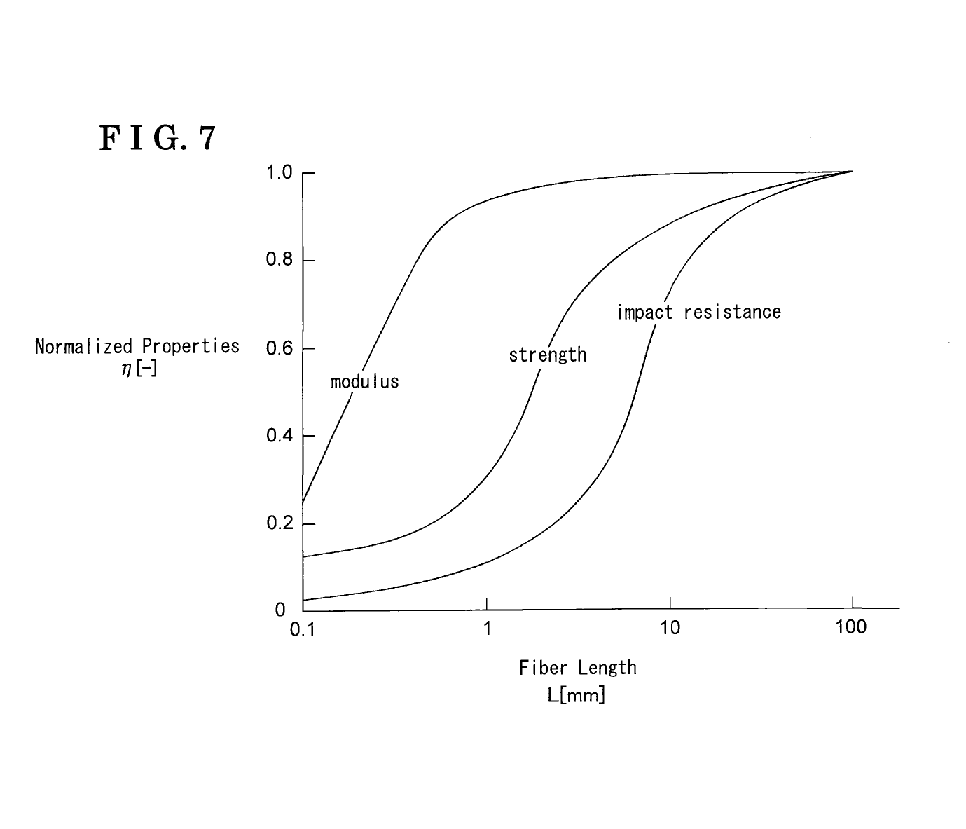

A second embodiment will be explained with reference to FIGS. 5 and 6. Hereinafter, a left side in FIG. 5 is referred to as a front side while a right side in FIG. 5 is referred to as a rear side. The similar members or components of the second embodiment to those of the first embodiment bear the same reference numerals. As illustrated in FIG. 5, an injection molding apparatus 2 according to the second embodiment includes an injection cylinder 60, an injection screw 70 accommodated within the injection cylinder 60, and a heating chamber 80. In FIG. 5, a mold clamping device, a heater for the injection cylinder 60, an operation control unit, and a temperature control unit, for example, are omitted.

The injection cylinder 60 is configured to extend in a predetermined axial direction. A void is formed in column at an inside of the injection cylinder 60. A nozzle 11 is attached to a front end of the injection cylinder 60. A molten resin within the injection cylinder 60 is injected from the nozzle 11 to a mold MO. The molten resin injected from the nozzle 11 is supplied to fill a cavity of the mold MO. The heater, which is provided at an outer periphery of the injection cylinder 60, is operated to heat the injection cylinder 60 so as to obtain a desired temperature of the molten resin within the injection cylinder 60.

The injection screw 70 is arranged within the injection cylinder 60 along an axial direction thereof to be rotatable about an axis. A drive unit 41 is connected to a rear end of the injection screw 70. The drive unit 41 includes, for example, an electric motor that generates a driving force for rotating the injection screw 70 about the axis. The injection screw 70 is a non-compression screw including a compression ratio of 1.0. In addition, the injection screw 70 includes an L/D ratio of 15-20. The injection screw 70 may serve as a low compression screw including the compression ratio equal to or smaller than 2.0.

That heating chamber 80 includes a case 81 forming an inner void, a microwave heater 82 serving as a selective heating device and the electromagnetic wave heating device, and a belt conveyor 83. A primary hopper 54 and a connection pipe 90 are connected to the case 81. The primary hopper 54 includes an upper opening and a lower opening. The lower opening of the primary hopper 54 is connected to a first opening 81a formed at an upper wall of the case 81 at a relatively right side in FIG. 5. The connection pipe 90 also includes an upper opening and a lower opening. The upper opening of the connection pipe 90 is connected to a second opening 81b formed at a lower wall of the case 81 at a relatively left side in FIG. 5.

Resin pellets formed by resin containing long carbon fibers, which will be hereinafter referred to as long carbon fiber reinforced pellets RF serving as fiber-reinforced pellets, are input to the primary hopper 54. As illustrated in FIGS. 6A and 6B, each of the long carbon fiber reinforced pellets RF is a resin and reinforcing fiber composite including a resin portion RE in column form containing polypropylene as a major component, and plural long carbon fibers F embedded in the resin portion RE. As illustrated in FIG. 6B, the plural long carbon fibers F are provided within the resin portion RE to be closely put together at an inner side of the resin portion RE, i.e., at a radially inner side portion of the resin portion RE when viewed in a plan direction of the long carbon fiber reinforced pellet RF. The long carbon fibers F may be embedded in the resin portion RE in a state to be bonded together by the sizing agent, for example.

The microwave heater 82 and the belt conveyor 83 are arranged within the case 81. The microwave heater 82 is attached to the upper wall of the case 81 to output or radiate a microwave downwardly. The belt conveyor 83 is provided at a lower side of the microwave heater 82. The belt conveyor 83 includes a drive pulley 83a and a driven pulley 83b supported to be rotatable on a base K, and a conveyor belt 83c wound on the drive pulley 83a and the driven pulley 83b. A drive unit that is connected to the drive pulley 83a is operated to rotate the drive pulley 83a. The conveyor belt 83c rotates in a counterclockwise direction in FIG. 5 by the rotation of the drive pulley 83a. Items or articles placed on an upper side portion of the conveyor belt 83c are conveyed in association with the rotation of the conveyor belt 83c.

Next, an injection molding method by the injection molding apparatus 2 including the aforementioned configuration will be explained.

First, the heater provided at the outer periphery of the injection cylinder 60 is operated to increase the temperature within the injection cylinder 60 to a desired temperature. In addition, the belt conveyor 83 within the heating chamber 80 is driven.

The long carbon fiber reinforced pellets RF are input to the primary hopper 54. The long carbon fiber reinforced pellets RF input to the primary hopper 54 are supplied from the lower opening thereof into the heating chamber 80. As illustrated in FIG. 5, the lower opening of the primary hopper 54 faces the upper side portion of the conveyor belt 83c of the belt conveyor 83. Thus, the long carbon fiber reinforced pellets RF supplied into the heating chamber 80 fall onto the conveyor belt 83c to be conveyed thereby.

The microwave output or radiated from the microwave heater 82 is applied to the long carbon fiber reinforced pellets RF conveyed by the conveyor belt 83c. Specifically, according to the present embodiment, the microwave heater 82 outputs or generates downwardly in FIG. 5 an electromagnetic wave including a wavelength of 1 m to 100 μm, i.e., a frequency of 300 MHz to 3 THz, absorbable by the long carbon fibers F in the long carbon fiber reinforced pellets RF. The long carbon fibers F embedded in the resin portions RE of the long carbon fiber reinforced pellets RF are immediately or instantaneously heated by absorbing the microwave output from the microwave heater 82. The heat of the long carbon fiber reinforced pellets RF is transmitted to the resin surrounding the long carbon fibers F. The resin portions RE are heated accordingly. In a case where the long carbon fibers F are bonded by the sizing agent, for example, the heat from the long carbon fibers F causes the sizing agent to be heated.

The long carbon fibers F in the long carbon fiber reinforced pellets RF are heated by the microwave heater 82, however, the resin portions RE formed by polypropylene resin not including a polarity are inhibited from being heated. That is, the microwave heater 82 selectively heats the long carbon fibers F (alternatively, the sizing agent) in the long carbon fiber reinforced pellets RF. The long carbon fibers F in the long carbon fiber reinforced pellets RF are closely put together at an inner side, i.e., in the vicinity of the center, of each of the resin portions RE. Thus, the resin portion RE generates heat from the inner side thereof by receiving the heat from the long carbon fibers F. The inner side of the resin portion RE is softened and melted by the heat while the outer side, i.e., front surface side, is unlikely to be softened because of a poor thermal transmission. As a result, each of the long carbon fiber reinforced pellets RF is melted at the inner side portion though the outer side portion is hard. Thus, the long carbon fiber reinforced pellets RF move, while maintaining shapes thereof, on the belt conveyor 83. The long carbon fibers F closely put together at the center of each of the resin portions RE move within the resin portion RE to be uniformly spread therein.

The long carbon fiber reinforced pellets RF on the belt conveyor 83 then fall from the belt conveyor 83. The connection pipe 90 is positioned immediately blow a position where the long carbon fiber reinforced pellets RF fall from the belt conveyor 83. Thus, the long carbon fiber reinforced pellets RF are introduced to the connection pipe 90 to be supplied into the injection cylinder 60. In this case, the lower opening of the connection pipe 90 faces the vicinity of the rear end portion of the injection screw 70 within the injection cylinder 60. As a result, the long carbon fiber reinforced pellets RF are supplied from the connection pipe 90 to a void within the injection cylinder 60 formed between the injection cylinder 60 and the vicinity of the rear end portion of the injection screw 70. At this time, because each of the long carbon fiber reinforced pellets RF is in a solidified state in which the resin portion RE forming the outer side portion of the long carbon fiber reinforced pellet RF is not melted, the long carbon fiber reinforced pellets RF are smoothly supplied within the injection cylinder 60 without being stuck to an inlet port of the injection cylinder 60.

The long carbon fiber reinforced pellets RF supplied within the injection cylinder 60 are kneaded and mixed by the rotation of the injection screw 70. The injection screw 70 serves as the non-compression screw including the compression ratio of 1.0 and thus includes a small kneading and compressing ability relative to the resin. Nevertheless, because the inner side portion of each of the long carbon fiber reinforced pellets RF has been already softened and melted when the long carbon fiber reinforced pellets RF are supplied to the injection screw 70, the long carbon fiber reinforced pellets RF may be easily kneaded and mixed even by the rotation force of the injection screw 70 as the non-compression screw. The resin in the long carbon fiber reinforced pellet RF is melted by the heat from the injection cylinder 60 and the long carbon fibers F are uniformly dispersed in the molten resin. In a case where the long carbon fibers F in the long carbon fiber reinforced pellets RF are bonded by the sizing agent, the sizing agent is softened and melted by the heat from the long carbon fibers F. Thus, the bonding force among the long carbon fibers F is weakened. The rotation of the injection screw 70 causes the long carbon fibers F in the long carbon fiber reinforced pellets RF to be easily fibrillated accordingly. The long carbon fibers F that are fibrillated are uniformly dispersed within the molten resin. The molten resin including the uniformly dispersed long carbon fibers F is injected from the nozzle 11. Further, the injection screw 70 is the non-compression screw including the compression ratio of 1.0. Thus, the shearing force of the injection screw 70 applied, in a state where the injection screw 70 rotates within the injection cylinder 60, relative to the molten resin and the long carbon fibers passing through the void between the injection screw 70 and the injection cylinder 60 is small. The long carbon fibers F dispersed within the molten resin may be restrained from being excessively broken by the shearing force of the injection screw 70.

Accordingly, the injection molding apparatus 2 of the second embodiment includes the microwave heater 82 selectively heating the long carbon fibers F within the long carbon fiber reinforced pellets RF each of which includes the resin portion RE containing polypropylene resin as the main component and including the plural long carbon fibers F, the injection cylinder 60 to which the long carbon fiber reinforced pellets RF heated by the microwave heater 82 are supplied, and the injection screw 70 arranged to be rotatable within the injection cylinder 60 to knead and mix the long carbon fiber reinforced pellets RF supplied into the injection cylinder 60. The injection screw 70 is the non-compression screw including the compression ratio of 1.0.

According to the second embodiment, the long carbon fibers F within the long carbon fiber reinforced pellets RF in each of which the plural long carbon fibers F are embedded in the resin portion RE are selectively heated by the microwave heater 82 so that the long carbon fiber reinforced pellets RF may be heated as in an internal melted state. In addition, because the long carbon fiber reinforced pellets RF in the internal melted state are supplied to the injection cylinder 60, even the injection screw 70 as the non-compression screw may sufficiently knead and mix the resin and uniformly disperse the long carbon fibers F in the resin. Further, because of the injection screw 70 as the non-compression screw, the shearing force applied to the molten resin and the long carbon fibers F is relatively small. Thus, the long carbon fibers F may be restrained from being excessively broken by the shearing force.

The aforementioned embodiments may be appropriately modified and changed. For example, according to the first embodiment, the second screw portion 22 is a non-compression screw. Alternatively, the second screw portion 22 may be a low compression screw including the compression ratio of 1.0 to 2.0. As long as the compression ratio of the second screw portion 22 falls within such range, the long carbon fibers are restrained from being excessively broken. In addition, according to the second embodiment, the injection screw 70 is a non-compression screw. Alternatively, the injection screw 70 may be a low compression screw including the compression ratio of 1.0 to 2.0. As long as the compression ratio of the injection screw 70 falls within such range, the long carbon fibers are restrained from being excessively broken.

According to the first and second embodiments, the long carbon fiber assemblies S/long carbon fiber reinforced pellets RF are heated while being conveyed to move by the belt conveyor 33, 83. Alternatively, the long carbon fiber assemblies S/long carbon fiber reinforced pellets RF may be heated by any other conveyor device of, for example, rotating drum type, screw type, mixing type, or fluidized drying type. According to the first embodiment, it has been experimentally confirmed that, when the long carbon fiber assemblies S are positioned to overlap one another in a state where the long carbon fiber assemblies S are heated by the microwave heater 32, conduction occurs among the long carbon fiber assemblies S to generate spark, which results in burning with flame. The long carbon fiber assemblies S are thus burnt. Therefore, the long carbon fiber assemblies S may be heated while moving in a state to have appropriate intervals one another, for example, approximately 10mm intervals.

In addition, according to the first embodiment, the long carbon fiber assemblies S (long carbon fiber assembly L) are heated by the microwave heater 32. At this time, as long as the bonding force among the long carbon fibers within the long carbon fiber assemblies S (long carbon fiber assembly L) is weakened, any heating method may be applied. For example, the long carbon fiber assemblies S (long carbon fiber assembly L) may be heated by hot wind. In order to instantaneously heat the long carbon fiber assemblies S (long carbon fiber assembly L), however, an electromagnetic wave heater such as a microwave heater, for example, may be desirable. In this case, the wavelength of electromagnetic wave may be specified depending on the long carbon fibers or the sizing agent that are heated.

Further, according to the second embodiment, the microwave heater 82 is used to heat the long carbon fibers F within the long carbon fiber reinforced pellets RF. Alternatively, depending on the long carbon fibers and the sizing agent to be used, a heater for outputting an electromagnetic wave including a wavelength that is most absorbable by the long carbon fibers and the sizing agent, i.e., a heater that outputs near-infrared ray, such as a halogen lamp, for example, or a heater that outputs far-infrared ray, such as a ceramic heater, for example, may be used. As long as the long carbon fibers F or the sizing agent are selectively heated, the usage of the electromagnetic wave heater is not necessary.

Furthermore, according to the first and second embodiments, the long carbon fibers are used as the reinforcing fibers. Alternatively, reinforcing fibers except for the long carbon fibers, for example, glass fibers, aramid fibers, boron fibers, or polyethylene fibers, may be used. In this case, in order to heat the aforementioned fibers, a hot air heater or an infrared heater may be used. In order to improve dispersibility of the fibers, a mixing element of, for example, Maddock type, Dulmadge type, or pin type may be provided. The embodiments may be appropriately modified or changed accordingly.

In the aforementioned embodiments, the excessive breaking of the long carbon fibers corresponds to a case where each of the long carbon fibers supplied to the injection cylinder 10, 60 is broken and the length thereof becomes smaller than 40% of an initial length, i.e., the length obtained before the long carbon fibers are supplied to the injection cylinder 10, 60. For example, in a case where the length of the long carbon fiber before the long carbon fiber is supplied to the injection cylinder 10, 60 is 10 mm, and the length of the long carbon fiber in the resin injected from the injection cylinder 10, 60 is smaller than 4mm, it is defined that the excessive breaking of the long carbon fibers occurs due to the shearing force applied to the long carbon fibers by the rotation of the two-stage screw 20/injection screw 70 within the injection cylinder 10, 60.

In addition, in the aforementioned embodiments, the non-compression screw corresponds to a screw including the compression ratio of 1.0. The low compression screw corresponds to a screw including the compression ratio close to 1.0.

The long carbon fiber assemblies S (long carbon fiber assembly L) are assemblies of plural long carbon fibers bonded by the sizing agent serving as a converging agent to be bundled. In this case, the long carbon fiber assemblies S supplied to the injection cylinder 10 may be in chopped strand form obtained by a cutting of the long carbon fibers by predetermined lengths along a lengthwise direction. For example, each of the long carbon fiber assemblies S includes a 10mm length in chopped strand form. In addition, the long carbon fiber assemblies S in chopped strand form or the long carbon fiber assembly L in roving form in which a plurality of very long carbon fibers are bonded by the sizing agent may be applied. In a case where the long carbon fiber assembly L in roving form, i.e., the long carbon fiber assembly L serving as a roving material, is used, the roving material may be cut to predetermined lengths after being heated to form the long carbon assemblies S in chopped strand form which are then supplied to the injection cylinder 10.

According to the aforementioned first embodiment, the heating device constituted by the microwave heater 32 may include any heating method as long as the long carbon fiber assemblies S (long carbon fiber assembly L) are heated. At this time, however, the long carbon fiber assemblies S (long carbon fiber assembly L) may be desirably heated for a short time period. Specifically, an electromagnetic wave heating device outputting an electromagnetic wave that includes a wavelength absorbable by the long carbon fibers and/or the sizing agent in the long carbon fiber assemblies S (long carbon fiber assembly L) may be desirably utilized so as to instantaneously heat the long carbon fiber assemblies S (long carbon fiber assembly L) by causing the long carbon fibers and/or the sizing agent in the long carbon fiber assemblies S (long carbon fiber assembly L) to absorb the electromagnetic wave. The wavelength of the electromagnetic wave may be specified depending on material characteristics of the long carbon fiber assemblies S (long carbon fiber assembly L) or the sizing agent to be used. For example, in a case where the long carbon fiber assemblies S (long carbon fiber assembly L) formed by the plural long carbon fibers that are bonded by the sizing agent are used, a microwave heater outputting a microwave that includes a frequency of 300 MHz to 3 THz, i.e., a wavelength of 1 m to 100 μm, may be desirably applied. The heating device may heat the long carbon fibers in the long carbon fiber assemblies S (long carbon fiber assembly L). In this case, the sizing agent is heated by receiving the heat of the long carbon fibers. Alternatively, the sizing agent bonding the long carbon fibers may be directly heated. For example, in a case where the sizing agent is formed by a material including a polarity, the electromagnetic wave heating device may be utilized for outputting an electromagnetic wave that includes frequency by which the sizing agent is heated.

According to the second embodiment, the injection screw 70 may include the compression ratio of 1.0 to 2.0. That is, the compression ratio of the injection screw 70 may be equal to or smaller than 2.0. Accordingly, the shearing force applied to the long carbon fibers F passing through the void between the injection cylinder 60 and the injection screw 70 is small to thereby inhibit the long carbon fibers F from being excessively broken. In addition, the injection screw 70 may include the L/D ratio of 15 to 20. In a case where the L/D ratio of the injection screw 70 is smaller than 15, the long carbon fibers F are inhibited from being sufficiently kneaded or dispersed in the resin. On the other hand, in a case where the L/D ratio is greater than 20, a time period during which the long carbon fibers F receive the shearing force is elongated, which may cause the excessive breaking of the long carbon fibers F during the kneading of the long carbon fibers F.

According to the second embodiment, the microwave heater 82 serving as the selective heating device may include any heating method as long as the long carbon fibers F in the long carbon fiber reinforced pellets RF are selectively heated, i.e., the long carbon fibers F are heated and the resin portions RE are not heated in the long carbon fiber reinforced pellets RF. At this time, however, the long carbon fibers F may be desirably heated for a short time period. Specifically, an electromagnetic wave heating device outputting an electromagnetic wave that includes a wavelength absorbable by the long carbon fibers F in the long carbon fiber reinforced pellets RF may be desirably utilized so as to selectively and instantaneously heat the long carbon fibers F by causing the long carbon fibers F to absorb the electromagnetic wave. The wavelength of the electromagnetic wave output by the electromagnetic wave heating device may be specified depending on the long carbon fibers F to be used. For example, the microwave heater 82 may desirably output the microwave that includes a frequency of 300 MHz to 3 THz, i.e., a wavelength of 1 m to 100 μm. That is, the long carbon fibers F selectively heated by the microwave heater 82 may be desirably used. In addition, in a case where the long carbon fibers F in the long carbon fiber reinforcing pellets RE are bonded by the sizing agent, the sizing agent is contained in the long carbon fibers F. The microwave heater 82 may selectively heat the sizing agent bonding the plural long carbon fibers F.

In this case, the resin component in the long carbon fiber reinforced pellets RF may be non-polar. Specifically, the resin component in the long carbon fiber reinforced pellets RF may be polypropylene (PP) resin. PP resin is non-polar and thus is unlikely heated by the microwave heater 82. As a result, the long carbon fibers F in the long carbon fiber reinforced pellets RF may be selectively heated.

According to the aforementioned first embodiment, the second screw portion 22 includes the compression ratio ranging from 1.0 to 2.0.

The second screw portion 22 includes a low compression ratio so that the long carbon fibers passing through the void between the injection cylinder 10 and the second screw portion 22 are inhibited from being excessively broken by the shearing force applied to the long carbon fibers by the rotation of the second screw portion 22 within the injection cylinder 10. In this case, the second screw portion 22 may desirably include the compression ratio ranging from 1.0 to 2.0. That is, the second screw portion 22 may desirably include the compression ratio equal to or smaller than 2.0. Accordingly, the shearing force applied to the long carbon fibers passing through the void between the injection cylinder 10 and the second screw portion 22 is small to thereby inhibit the long carbon fibers from being excessively broken.

In addition, according to the aforementioned first embodiment, the second screw portion 22 includes the L/D ratio ranging from 10 to 15.

Accordingly, the long carbon fibers are sufficiently dispersed in the molten resin and are inhibited from being excessively broken. In a case where the UD ratio of the second screw portion 22 is smaller than 10, the long carbon fibers are inhibited from being sufficiently kneaded or dispersed. On the other hand, in a case where the L/D ratio of the second screw portion 22 is greater than 15, a time period during which the long carbon fibers pass through the void between the injection cylinder 10 and the second screw portion 22 is elongated, which may cause the excessive breaking of the long carbon fibers while the long carbon fibers are kneaded.

Further, according to the aforementioned first embodiment, the microwave heater 32 serves as the electromagnetic wave heating device outputting the electromagnetic wave that includes the wavelength absorbable by the long carbon fibers or the sizing agent.

Accordingly, the long carbon fiber assemblies S (long carbon fiber assembly L) may be instantaneously heated.

According to the aforementioned second embodiment, the long carbon fibers F in the long carbon fiber reinforced pellets RF in each of which the plural long carbon fibers F are contained in the thermoplastic resin is selectively heated by the microwave heater 82. The heat of the long carbon fibers F is transmitted to the resin portions RE so that the resin portions RE are heated and melted. The resin forming the inner side portion, i.e., the center portion, of each of the long carbon fiber reinforced pellets RF immediately receives the heat from the long carbon fibers F so as to be softened immediately. On the other hand, the resin forming the outer side portion, i.e., the front surface portion, of each of the long carbon fiber reinforced pellets RF is unlikely to receive the heat from the long carbon fibers F so that the softening proceeds slowly. Therefore, each of the long carbon fiber reinforced pellets RF is in a melted state at the inner side portion and in an unmelted state at the outer side portion.

The long carbon fiber reinforced pellets RF in the internal melted state are supplied into the injection cylinder 60. At this time, because each of the long carbon fiber reinforced pellets RF is in the solidified state in which the resin forming the outer side portion of the long carbon fiber reinforced pellet RF is not melted, the long carbon fiber reinforced pellets RF are smoothly supplied within the injection cylinder 60 without being stuck to the inlet port of the injection cylinder 60. The long carbon fiber reinforced pellets RF supplied to the injection cylinder 60 are kneaded and mixed by the injection screw 70 within the injection cylinder 60. The injection screw 70 is either the low compression screw or the non-compression screw. Thus, a kneading performance of the injection screw 70 is lower than a normal screw, however, the injection screw 70 serving as the low compression screw or the non-compression screw may sufficiently knead and mix the resin because of the internal melted state of each of the long carbon fiber reinforced pellets RF. The resin that is kneaded and mixed is sufficiently melted by heat from the injection cylinder 60. In addition, the long carbon fibers F may be uniformly dispersed in the resin. Further, because the injection screw 70 serves as the low compression screw or the non-compression screw, the shearing force applied to the long carbon fibers F when the long carbon fibers F pass through the void between the injection screw 70 and the injection cylinder 60 by the rotation of the injection screw 70 within the injection cylinder 60 is relatively small. Thus, the long carbon fibers F may be restrained from being excessively broken by the shearing force.

In addition, according to the aforementioned second embodiment, the microwave heater 82 serves as the electromagnetic wave heating device outputting the electromagnetic wave that includes the wavelength absorbable by the long carbon fibers F.

Accordingly, the long carbon fibers F may be selectively and instantaneously heated.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An injection molding apparatus comprising:
a heating device heating reinforcing fiber assemblies that are formed by plural reinforcing fibers bonded together by a sizing agent;
an injection cylinder to which a thermoplastic resin and the reinforcing fiber assemblies heated by the heating device are supplied;
a first screw arranged to be rotatable within the injection cylinder, the first screw compressing and kneading the thermoplastic resin supplied into the injection cylinder within the injection cylinder;
a second screw arranged within the injection cylinder and connected to an end portion of the first screw to be integrally rotatable with the first screw, the second screw fibrillating the reinforcing fiber assemblies supplied into the injection cylinder and dispersing reinforcing fibers obtained by the fibrillation into the thermoplastic resin;
a resin supply portion supplying the thermoplastic resin to a void within the injection cylinder, the void being formed between the injection cylinder and the first screw; and
a reinforcing fiber supply portion supplying the reinforcing fiber assemblies heated by the heating device to a void within the injection cylinder, the void being formed between the injection cylinder and the second screw, wherein the second screw serves as one of a non-compression screw and a low compression screw including a low compression ratio by which the reinforcing fibers are inhibited from being excessively broken at a time of receiving a shearing force generated by a rotation of the second screw within the injection cylinder.

2. The injection molding apparatus according to claim 1, wherein the second screw includes a compression ratio ranging from 1.0 to 2.0.

3. The injection molding apparatus according to claim 1, wherein the second screw includes an L/D ratio ranging from 10 to 15.

4. The injection molding apparatus according to claim 1, wherein the heating device serves as an electromagnetic wave heating device outputting an electromagnetic wave that includes a wavelength absorbable by the reinforcing fibers or the sizing agent.

5. An injection molding apparatus comprising:
a selective heating device selectively heating plural reinforcing fibers in fiber-reinforced pellets each of which includes a thermoplastic resin containing the plural reinforcing fibers;
an injection cylinder to which the fiber-reinforced pellets heated by the selective heating device are supplied; and
an injection screw arranged to be rotatable within the injection cylinder to knead the fiber-reinforced pellets supplied into the injection cylinder, wherein
the injection screw serves as one of a non-compression screw and a low compression screw including a low compression ratio by which the reinforcing fibers are inhibited from being excessively broken at a time of receiving a shearing force generated by a rotation of the injection screw within the injection cylinder.

6. The injection apparatus according to claim 5, wherein the selective heating device serves as an electromagnetic wave heating device outputting an electromagnetic wave that includes a wavelength absorbable by the reinforcing fibers.
